(19) United States
(12) Patent Application Publication
(10) Pub. No.: US 2025/0061388 A1
(43) Pub. Date: Feb. 20, 2025

(54) TOKENIZATION OF EMBODIED EMISSIONS OF INFORMATION TECHNOLOGY COMPONENTS

(71) Applicant: International Business Machines Corporation, Armonk, NY (US)

(72) Inventors: Khaalid Persaud Juggan MCMILLAN, Poughkeepsie, NY (US); John TOROK, Poughkeepsie, NY (US); Dustin DEMETRIOU, New York, NY (US); Andrew C. M. HICKS, Highland, NY (US); Michael James BECHT, Poughkeepsie, NY (US)

(21) Appl. No.: 18/449,493

(22) Filed: Aug. 14, 2023

(51) Int. Cl. G06Q 10/0631

(52) U.S. Cl. CPC G06Q 10/0631

(57) ABSTRACT

Techniques relating to information technology (IT) are disclosed. These techniques include identifying a token relating to embodied emissions for an IT hardware component. The techniques further include determining embodied emissions for the IT hardware component that have been offset, based on the token. The techniques further include recording the offset of the embodied emissions for the IT hardware component, including: modifying a sticky bit for the IT hardware component, wherein the sticky bit reflects the offset of the embodied emissions, wherein the modification of the sticky bit is irreversible, and wherein the sticky bit is integrated into the IT hardware component.

### BACKGROUND

The present invention relates to information technology (IT), and more specifically, to tokenization of embodied emissions of IT components.

### SUMMARY

Embodiments include a method. The method includes identifying a token relating to embodied emissions for an information technology (IT) hardware component. The method further includes determining embodied emissions for the IT hardware component that have been offset, based on the token. The method further includes recording the offset of the embodied emissions for the IT hardware component, including: modifying a sticky bit for the IT hardware component, wherein the sticky bit reflects the offset of the embodied emissions, wherein the modification of the sticky bit is irreversible, and wherein the sticky bit is integrated into the IT hardware component.

Embodiments further include a system. The system includes one or more computer processors and a memory containing a program which when executed by the one or more computer processors performs an operation. The operations include identifying a token relating to embodied emissions for an IT hardware component. The operations further include determining embodied emissions for the IT hardware component that have been offset, based on the token. The operations further include recording the offset of the embodied emissions for the IT hardware component, including: modifying a sticky bit for the IT hardware component, wherein the sticky bit reflects the offset of the embodied emissions, wherein the modification of the sticky bit is irreversible, and wherein the sticky bit is integrated into the IT hardware component.

Embodiments further include a computer program product, including a computer-readable storage medium having computer-readable program code embodied therewith, the computer-readable program code executable by one or more computer processors to cause the one or more computer processors to perform an operation. The operation includes identifying a token relating to embodied emissions for an IT hardware component. The operation further includes determining embodied emissions for the IT hardware component that have been offset, based on the token. The operation further includes recording the offset of the embodied emissions for the IT hardware component, including: modifying a sticky bit for the IT hardware component, wherein the sticky bit reflects the offset of the embodied emissions, wherein the modification of the sticky bit is irreversible, and wherein the sticky bit is integrated into the IT hardware component.

### BRIEF DESCRIPTION OF THE DRAWINGS

FIG. 1 illustrates a computing environment for tokenization of embodied emissions of IT components, according to one embodiment.

FIG. 2 is a flowchart illustrating tokenizing embodied emissions of IT components, according to one embodiment.

FIG. 3 illustrates persistent tokenization of embodied emissions of IT components, according to one embodiment.

FIG. 4 is a flowchart illustrating using pseudo-boolean logic for tokenizing embodied emissions of IT components, according to one embodiment.

FIG. 5 is a flowchart illustrating identifying offset embodied emissions for IT components, according to one embodiment.

### DETAILED DESCRIPTION

As the shift of IT operations continues towards cloud, hyper-scale, and co-located data centers, many entities have begun to disassociate from their IT infrastructure by no longer physically managing their systems. Furthermore, sustainability of IT infrastructure is increasing importance, as carbon accounting becomes prevalent. While the specifics of carbon accounting requirements remain uncertain, monitoring and reporting carbon emissions for IT assets is expected to be vitally important.

One or more techniques disclosed herein can be used to digitally record, monitor, mitigate, and offset the embodied emissions associated with the deployment of IT assets (e.g., hardware components, used in a datacenter or another suitable system). The offset of embodied emissions can be managed through the IT system's operating system (OS), firmware, or both, and tracked permanently using sticky bits on the hardware component that are architected to be irreversible.

In an embodiment, one or more of these techniques leverages the calculation of a product's carbon footprint through verification (e.g., third party verification) establishing the emissions associated with the manufacture of the IT hardware. These can be referred to as embodied emissions, for that hardware. For example, the embodied emissions associated with a component can be discretized into tokens that represent a fraction of the embodied emissions. A customer (e.g., an entity managing an IT workload) would purchase a token and use it to execute their workloads, subsequently an offset would be purchased, and a sticky bit tied to the hardware would flip indicating the removal of a fraction of that component's embodied emissions. Once the component has been completely offset (e.g., sufficient offset tokens have been purchased to offset the entirety of the embodied emissions for the component), the component can be considered to have net-zero embodied emissions and can be accounted accordingly (e.g., through digital self reporting via an OS). Further, in an embodiment, the sticky bits can be used to allow selection of a “more green” (e.g., more offset) entity with which to place a workload.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

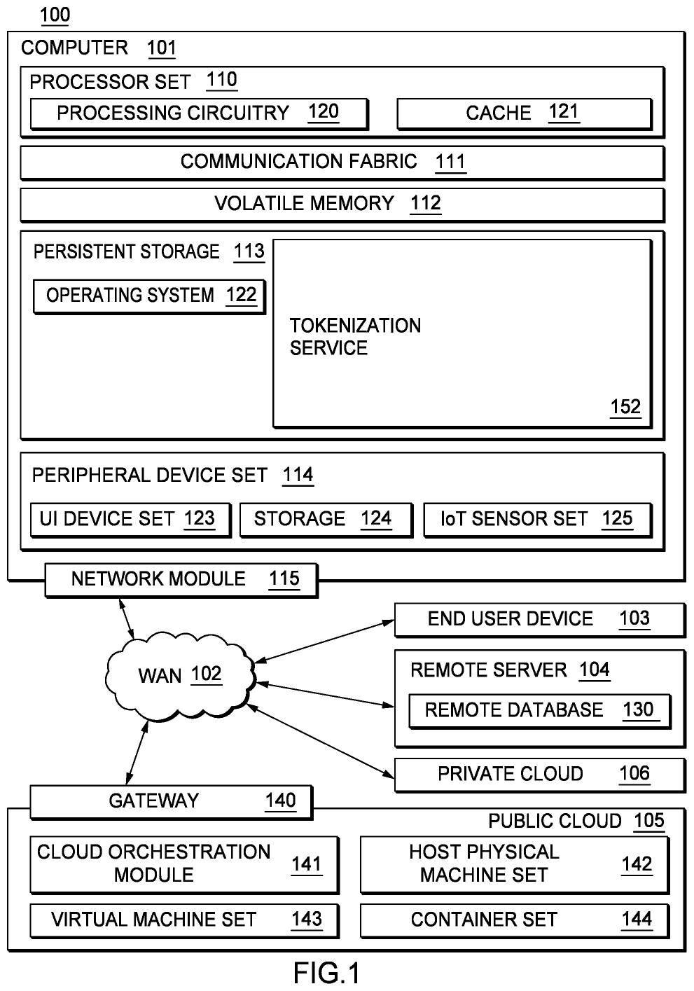

FIG. 1 illustrates a computing environment for tokenization of embodied emissions of IT components, according to one embodiment. A computing environment 100 contains an example of an environment for the execution of at least some of the computer code involved in performing the inventive methods, such as tokenization service 152 for tokenization of embodied emissions of IT components. In addition to block 152, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 152, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 152 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 152 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

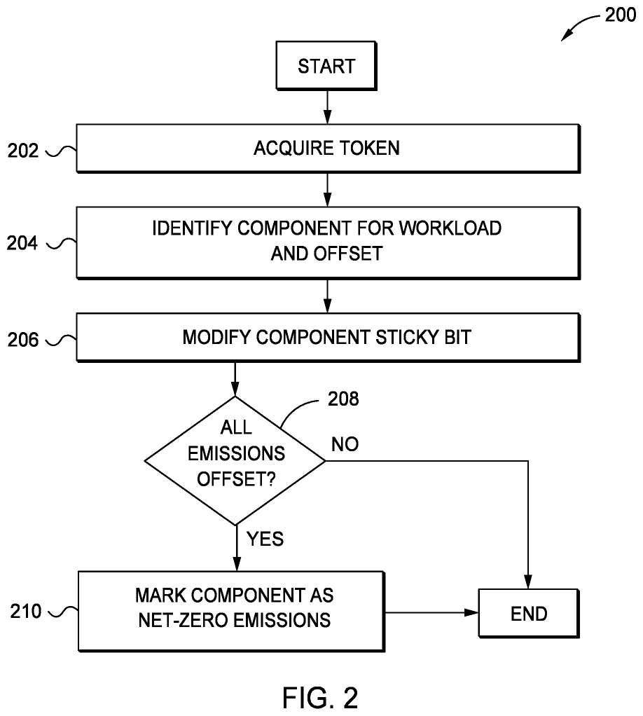

FIG. 2 is a flowchart 200 illustrating tokenizing embodied emissions of IT components, according to one embodiment. At block 202, an entity with IT operations acquires a token. In an embodiment, a token is used both to allow a user to perform an IT operation (e.g., execute a workload at a distributed compute system) using an IT hardware component, and offset a portion of the embodied emissions for that hardware component. In an embodiment, the entity with IT operations can use the token to offset embodied emission for IT components. For example, embodied emissions can represent the CO₂ equivalent (CO₂e) emissions in providing the IT components. This can include CO₂e emissions for raw material extraction, manufacturing, transportation, packaging, end-of-life, and any other aspects of the life cycle of an IT component. In an embodiment CO₂e includes CO₂ emissions and any suitable equivalent emissions (e.g., any suitable greenhouse gas emissions).

The embodied emissions for each IT component can be quantified (e.g., through estimation by a suitable third party). For example, a suitable calculator (e.g., from a certified third party) can be used to estimate the embodied emissions for a given IT component. The entity with IT operations can then purchase offset tokens to offset the estimated embodied emissions. While one or more embodiments disclosed herein focus on carbon offset (e.g., for CO₂e emissions), this is merely an illustrative example and the token can relate to any suitable item (e.g., any suitable environmental offset or any other suitable offset).

In an embodiment, the embodied emissions for a given IT component can be discretized into tokens that represent a fraction of the embodied emissions for that component. An entity with IT operations can acquire a token (e.g., purchase a token) and us it to perform IT operations (e.g., execute workloads). An offset can then be purchased, to offset a portion of embodied emissions corresponding to the token, and that offset can be immutably memorialized in the IT component using a sticky bit (e.g., as discussed further below). In an embodiment, tokens can be acquired in a marketplace, and can be certified by a suitable third party certification body (e.g., a suitable governmental agency or any other suitable third party certification body).

In an embodiment, multiple entities can acquire tokens to offset shared IT components. For example, a data center could be used by multiple different entities. Each entity could acquire one or more tokens, and use those tokens to offset embodied emissions for IT components in the data center. As discussed further below, sticky bits (e.g., immutable bits implemented using pseudo-boolean circuits) can be set by each different entity to represent the portion of embodied emissions offset, for a given IT

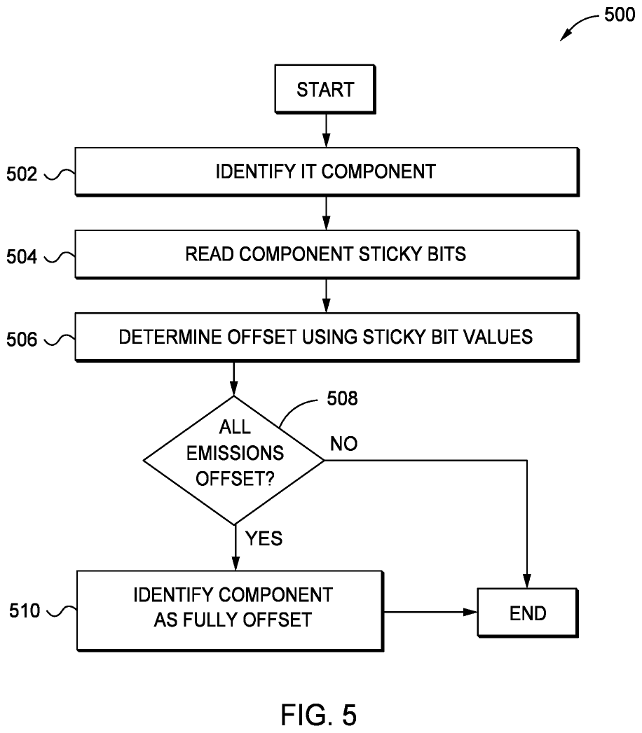

At block 204, a tokenization service (e.g., the tokenization service 152 illustrated in FIG. 1) identifies a component for workload and offset. In an embodiment, the tokenization service identifies a component that is closest to having its embodied emissions fully offset. For example, as discussed further below, each IT component can be associated with one or more sticky bits that represent the embodied emissions remaining to be offset. The tokenization service can analyze these sticky bits to identify the remaining emissions for offset for a given component. This is discussed further, below, with regard to FIG. 5.

The tokenization service can then select the component with the fewest remaining embodied emissions for offset. For example, a given component may be associated with fewer embodied emissions than another component. As another example, a given component may have already had embodied emissions partially offset. In an embodiment, selecting the token with the fewest remaining embodied emissions to be offset allows the tokenization service to fully offset embodied emissions for components. Selecting a component with the fewest remaining embodied emissions is merely an example, however, and the tokenization service can select the component for offset based on any suitable criteria. For example, the tokenization service could select the component with the fewest emissions during operation, could select a component based on age (e.g., could select older components first to ensure components are fully offset before going out of service), could select a component randomly, or could use any other suitable criteria.

While this disclosure is focused on offset of embodied emissions for IT components, this is merely an example. One or more embodiments disclosed herein can be used for offset of any suitable items. Further, one or more embodiments disclosed herein can be used to offset any suitable emissions (e.g., non-embodied emissions) or any other suitable aspect of an item.

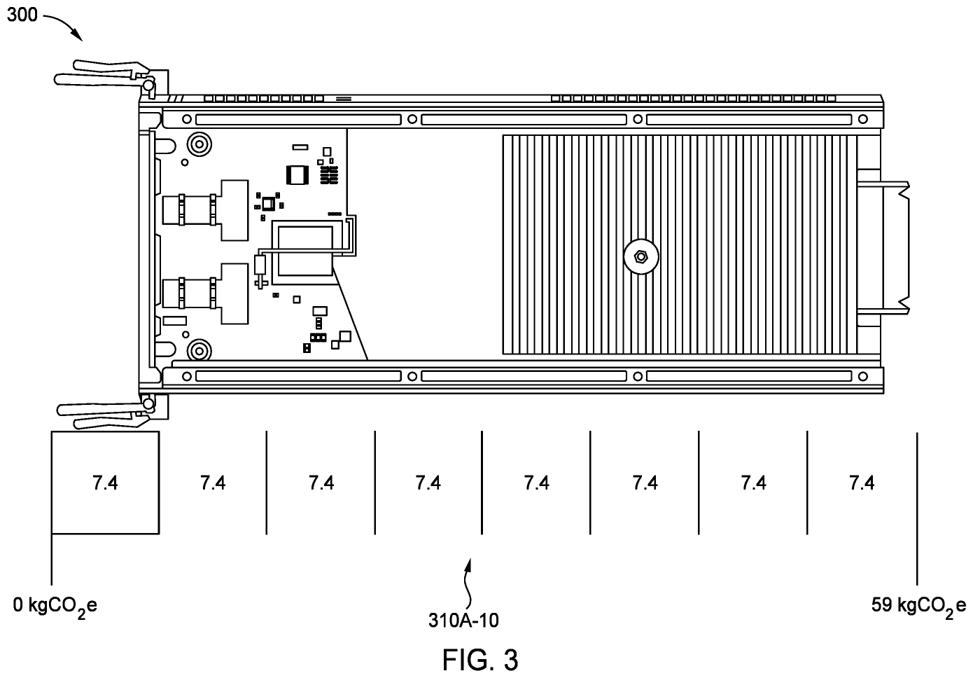

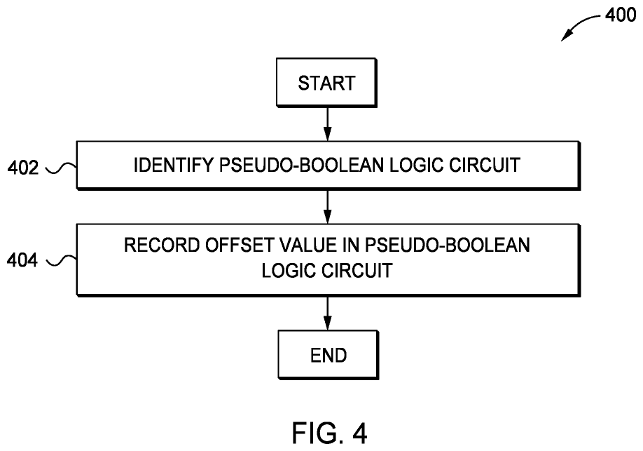

At block 206, the tokenization service modifies the component sticky bit. In an embodiment, the tokenization service flips the value of a persistent bit associated with the component, to reflect the offset emissions. For example, the tokenization service can use a low energy pseudo-boolean analog circuit (e.g., a circuit implementing Heyting algebra) to implement the sticky bits and record the offset emissions. FIG. 3, below, illustrates one example of sticky bits for an IT component to record the offset of embodied emissions. FIG. 4, below, illustrates one example of modifying sticky bits to record the offset of embodied emissions.

In an embodiment, the sticky bit is architected into the IT component (i.e., is integrated into the IT component). The sticky bit is immutable and cannot be reversed. This is an example, and the sticky bit can be maintained using any suitable technique.

At block 208, the tokenization service determines whether all emissions have been offset. In an embodiment, a given IT component has a particular quantity of embodied emissions that can be offset through purchase a particular number of tokens. The purchase of each token is memorialized by changing the value of a stick bit associated with the component, as discussed further below with regard to FIGS. 3-4. The tokenization service can determine whether all sticky bits have been flipped (e.g., meaning all emissions have been offset). If all embodied emissions have been offset, the flow proceeds to block 210. Otherwise, the flow ends.

At block 210, the tokenization service marks the component as net-zero emissions. In an embodiment, once all embodied emissions for a component have been offset, the component can be marked as net-zero emissions. In one embodiment, the tokenization service sets another value associated with the component (e.g., another sticky bit) to reflect that the component has been fully offset and is now net-zero for embodied emissions. For example, this can act as a shortcut to allow a future software or hardware service to quickly identify components that have been fully offset. This is merely an example, however. The tokenization service can set any suitable value, or no value at all (e.g., the fact that all sticky bits have been flipped can indicate that the component is net-zero emissions, without setting an additional value).

In an embodiment, an OS associated with the IT component, firmware, or both, can identify net-zero components by reviewing this value, and can report these components. For example, the OS can digitally self report emissions offsets. This can include digitally self reporting to a third party (e.g., using a suitable application programming interface (API) and a suitable communication network (e.g., the Internet)), including a governmental organization.

FIG. 3 illustrates persistent tokenization of embodied emissions of IT components, according to one embodiment. In an embodiment, an IT component 300 is associated with a quantity of embodied emissions. These embodied emissions are divided into tokens 310A-N, each representing a portion of the embodied emissions. In an embodiment, each of these portions of embodied emissions can be offset by acquiring a token 310A-N, and this offset can be memorialized by changing the value of one or more sticky bits associated with the IT component 300 (e.g., sticky bits integrated into the hardware of the IT component 300). That is, changing the value of the sticky bits reflects the quantity of embodied emissions for the component that have been offset.

Using the illustrated example of FIG. 3, an IT component 300 is associated with 59 kgCO₂e of embodied emissions. The IT component 300 includes eight sticky bits corresponding to the tokens 310A-N, each of which represents ⅛ of the total embodied emissions (e.g., 7.4 kgCO₂e per sticky bit). Assume an entity offsets a fraction of the embodied emissions for the IT component 300, and receives one or more tokens reflecting this offset. One or more of the sticky bits associated with the tokens 310A-N can be set to reflect this offset. As discussed above, in an embodiment each sticky bit is immutable such that it cannot be changed after being set, and is tied to the IT component 300. Once all the sticky bits are set, another sticky bit (or another suitable value) can be set to reflect that all the embodied emissions for the IT component 300 have been offset (e.g., the IT component 300 is now net-zero emissions).

For example, assume an entity offsets exactly 7.4 kgCO₂e of carbon, and acquires a token reflecting this offset. The token can be applied to the IT component 300, and one of the sticky bits can be set to reflect the offset. Further, by using a pseudo-boolean logic circuit to implement the sticky bits, a portion of each bit can be immutably set. For example, assume an entity offsets 10 kgCO₂e and acquires a token reflecting this offset. A tokenization service (e.g., the tokenization service 152 illustrated in FIG. 1) can set one whole sticky bit (e.g., reflecting 7.4 gCO₂e of the total 10 gCO₂e) and another partial sticky bit (e.g., reflecting the remaining 2.6 gCO₂e of the total 10 gCO₂e). In an embodiment, partial sticky bits can be implemented by additional slicing of the carbon footprint into representative bits (e.g., dividing sticky bit into three separate bits to allow a portion to be set).

FIG. 4 is a flowchart 400 illustrating using pseudo-boolean logic for tokenizing embodied emissions of IT components, according to one embodiment. At block 402, a tokenization service (e.g., the tokenization service 152 illustrated in FIG. 1) identifies a pseudo-boolean logic circuit. In an embodiment, a low energy pseudo-boolean logic circuit implementing Heyting algebra can be used for sticky bits to reflect offset of embodied emissions for an IT component. For example, logic gates can be used as part of a pseudo-boolean analog logic circuit to store an immutable reflection of the carbon offset. The use of Heyting algebra is merely an example, and any suitable pseudo-boolean logic circuit can be used. Further, the use of a pseudo-boolean logic circuit itself is merely an example, and any technique to immutably store the offset value associated with a given IT component can be used.

At block 404, the tokenization service records the offset value in the pseudo-boolean logic circuit. For example, as discussed above in relation to FIG. 3, the tokenization service can set one or more sticky bits reflecting the emissions offset for the IT component. Further, as discussed above in relation to FIG. 3, using a pseudo-boolean logic circuit allows the tokenization service to partially set each sticky bit to reflect the portion of the sticky bit value corresponding to the offset.

FIG. 5 is a flowchart 500 illustrating identifying offset embodied emissions for IT components, according to one embodiment. At block 502, a tokenization service (e.g., the tokenization service 152 illustrated in FIG. 1) identifies the IT component. For example, an OS can analyze all, or some, IT components in use for carbon offset, and can report the current offset (e.g., to a third party).

At block 504, the tokenization service reads the component sticky bits. In an embodiment, as discussed above in relation to FIGS. 3-4, a pseudo-boolean analog circuit (e.g., implementing Heyting algebra) is used to implement immutable sticky bits reflecting the emissions offset for a particular IT component. The tokenization service can read these sticky bits for the component.

At block 506, the tokenization service determines the offset using the sticky bit values. In an embodiment, the tokenization service can identity a quantity of emissions offset associated with each fully set sticky bit. For example, each sticky bit can reflect a fraction of the whole embodied emissions for the IT component.

At block 508, the tokenization service determines whether all emissions have been offset. As discussed above, in an embodiment an additional sticky bit reflects whether all emissions have been offset. In this embodiment, the tokenization service reads this additional sticky bit. Further, in an embodiment the tokenization service can check this additional sticky bit before reading the individual sticky bits. If the sticky bit reflecting full offset is set, the tokenization service need not check the other stick bits. This is merely an example, and the tokenization service can read all the sticky bits to identify that the IT component is fully offset (e.g., determine that all sticky bits have been set), or can read any other suitable value. If all emissions are offset, the flow proceeds to block 510. If not, the flow ends.

At block 510, the tokenization service identifies the component as fully offset. In an embodiment, an OS, or another suitable hardware or software service, reports the IT component as fully offset (e.g., net-zero embodied emissions).

While the foregoing is directed to embodiments of the present invention, other and further embodiments of the invention may be devised without departing from the basic scope thereof, and the scope thereof is determined by the claims that follow.

What is claimed is:

1. A method comprising:
identifying a token relating to embodied emissions for an information technology (IT) hardware component;
determining embodied emissions for the IT hardware component that have been offset, based on the token; and
recording the offset of the embodied emissions for the IT hardware component, comprising:
modifying a sticky bit for the IT hardware component,
wherein the sticky bit reflects the offset of the embodied emissions,
wherein the modification of the sticky bit is irreversible, and
wherein the sticky bit is integrated into the IT hardware component.

2. The method of claim 1,
wherein the offset of the embodied emissions for the IT hardware component comprises a portion of a total quantity of embodied emissions for the IT hardware component,
wherein the sticky bit comprises one or more of a plurality of sticky bits integrated into the IT hardware component, and
wherein modifying the sticky bit reflects the portion of embodied emissions offset.

3. The method of claim 2, wherein modifying the sticky bit for the IT hardware component comprises:
modifying a pseudo-boolean logic circuit integrated into the IT hardware component.

4. The method of claim 3, wherein the pseudo-boolean logic circuit implements Heyting algebra.

5. The method of claim 2, further comprising:
determining that all embodied emissions for the IT hardware component have been offset; and
setting a further sticky bit for the IT hardware component, wherein the further sticky bit reflects that the IT hardware component is net-zero for embodied emissions.

6. The method of claim 1, wherein the embodied emissions comprise estimated CO₂ equivalent (CO₂e) emissions relating to manufacture of the IT hardware component.

7. The method of claim 6, wherein the embodied emissions relate to all of: (i) raw material extraction, (ii) manufacture, (iii) transportation, (iv) packaging, and (v) end of life for the IT hardware component.

8. The method of claim 6, wherein the embodied emissions are certified by a third party entity, prior to the offset.

9. The method of claim 1, wherein the IT hardware component relates to execution of workloads in a distributed computing system, the method further comprising:
executing a first workload using the IT hardware component based on the token.

10. The method of claim 9, wherein the distributed computing system comprises a cloud computing environment, and wherein the IT hardware component is one of a plural of hardware components used in the cloud computing environment.

11. A system, comprising:
one or more computer processors; and
a memory containing a program which when executed by the one or more computer processors performs an operation, the operation comprising:
identifying a token relating to embodied emissions for an information technology (IT) hardware component;
determining embodied emissions for the IT hardware component that have been offset, based on the token; and
recording the offset of the embodied emissions for the IT hardware component, comprising:
modifying a sticky bit for the IT hardware component,
wherein the sticky bit reflects the offset of the embodied emissions,
wherein the modification of the sticky bit is irreversible, and
wherein the sticky bit is integrated into the IT hardware component.

12. The system of claim 11,
wherein the offset of the embodied emissions for the IT hardware component comprises a portion of a total quantity of embodied emissions for the IT hardware component,
wherein the sticky bit comprises one or more of a plurality of sticky bits integrated into the IT hardware component, and
wherein modifying the sticky bit reflects the portion of embodied emissions offset.

13. The system of claim 12, wherein modifying the sticky bit for the IT hardware component comprises:
modifying a pseudo-boolean logic circuit integrated into the IT hardware component.

14. The system of claim 13, wherein the pseudo-boolean logic circuit implements Heyting algebra.

15. The system of claim 12, the operation further comprising:
determining that all embodied emissions for the IT hardware component have been offset; and
setting a further sticky bit for the IT hardware component, wherein the further sticky bit reflects that the IT hardware component is net-zero for embodied emissions.

16. A computer program product, comprising:
a computer-readable storage medium having computer-readable program code embodied therewith, the computer-readable program code executable by one or more computer processors to cause the one or more computer processors to perform an operation, the operation comprising:
identifying a token relating to embodied emissions for an information technology (IT) hardware component;
determining embodied emissions for the IT hardware component that have been offset, based on the token; and
recording the offset of the embodied emissions for the IT hardware component, comprising:
modifying a sticky bit for the IT hardware component,
wherein the sticky bit reflects the offset of the embodied emissions,
wherein the modification of the sticky bit is irreversible, and
wherein the sticky bit is integrated into the IT hardware component.

17. The computer program product of claim 16,
wherein the offset of the embodied emissions for the IT hardware component comprises a portion of a total quantity of embodied emissions for the IT hardware component,
wherein the sticky bit comprises one or more of a plurality of sticky bits integrated into the IT hardware component, and
wherein modifying the sticky bit reflects the portion of embodied emissions offset.

18. The computer program product of claim 17, wherein modifying the sticky bit for the IT hardware component comprises:
modifying a pseudo-boolean logic circuit integrated into the IT hardware component.

19. The computer program product of claim 18, wherein the pseudo-boolean logic circuit implements Heyting algebra.

20. The computer program product of claim 17, the operation further comprising:
determining that all embodied emissions for the IT hardware component have been offset; and
setting a further sticky bit for the IT hardware component, wherein the further sticky bit reflects that the IT hardware component is net-zero for embodied emissions.
